(19) United States
(12) Patent Application Publication
(10) Pub. No.: US 2008/0274629 A1
(43) Pub. Date: Nov. 6, 2008

(54) Serial Interface Converter

(76) Inventor: Donald A. Meyer, Charlotte, NC (US)

Correspondence Address: HOPE BALDAUFF HARTMAN, LLC, 1720 PEACHTREE STREET, N.W, SUITE 1010, ATLANTA, GA, 30309, US

(21) Appl. No.: 11/620,207

(22) Filed: Jan. 5, 2007

(51) Int. Cl. H01R 29/00

(52) U.S. Cl. 439/49

(57) ABSTRACT

A serial interface converter converts serial communications between two electronic devices, converting between to serial communication standards. The converter may include a housing with two standard cable ports, each for connecting to cables from one of the two electronic devices. The housing includes electrical connections between the two cable ports, where the electrical connections effect a remapping of the signals achieving the conversion. The housing can be rack-mountable.

### TECHNICAL FIELD

This application relates generally to networks. More particularly, this application relates to enabling serial communication between network elements.

### BACKGROUND

Frequently, electronic devices utilize serial techniques to communicate with each other, or with an end user. A device communicating using serial techniques sends data one bit at a time sequentially over a communications channel. The practice of serial communication has grown complicated over time with the diversity of vendors and interface standards which have built up around serial communications. As a result, enabling two differing devices in a network to communicate using serial communication can sometimes prove difficult. Even if the two devices utilize the same standard for wired electronic signaling, they may utilize different cables, connectors, and wiring schemes to electrically enable serial communication.

In one example of mismatched serial communication interfaces, a user may wish to enable serial communications between a console port of a CISCO device and a DATAKIT device. Both devices may utilize the RS-232 serial communication signaling standard and eight pin, eight conductor (8P8C) modular connectors, but use different wiring schemes. As such, connecting the devices may take a multitude of intermediary adapters and cable converters to convert the signals. One such configuration involves creating a proprietary RJ-45 to DSub25 adapter which is then mated to a “Cisco to RS-232 ” adapter using a gender changer or PORT MISER. Creating such an ad hoc cable/connector configuration is time intensive and may introduce several potential points-of-failure into the circuit, whether due to poorly connected cables or accidental disconnection of cables.

### SUMMARY

It should be appreciated that this Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Provided are apparatuses for enabling serial communications between two electronic devices. An apparatus includes a housing with a first and second cable port. The cable ports accept cable connectors conforming to a particular standard. The apparatus includes electrical connections for connecting the pins of the first and second cable ports, accomplishing a remapping of signals between the two ports.

Also provided are systems for remapping signals used in serial communication. The system receives two standard cable connectors, each carrying multiple electrical signals. The system electrically connects the multiple electrical signals between the two cable connectors, remapping the multiple electrical signals between two wiring schemes.

Additionally provided are apparatuses for enabling serial communications between two devices utilizing different serial wiring schemes. The apparatus is composed of a rack-mountable housing with two 8P8C standard modular jacks for receiving 8P8C cables. The apparatus houses a plurality of electrical connections between the two 8P8C standard modular jacks, and the electrical connections effect a remapping of the signals between the two jacks.

Other systems and apparatuses according to embodiments will be or become apparent to one with skill in the art upon review of the following drawings and Detailed Description. It is intended that all such additional systems and apparatuses be included within this description, be within the scope of the present invention, and be protected by the accompanying claims.

### BRIEF DESCRIPTION OF THE DRAWINGS

FIG. 1 is a block diagram illustrating an apparatus for enabling serial communication between electronic devices according to one or more embodiments;

FIG. 2 depicts a null flow control serial signal remapping inside a serial interface converter according to one or more embodiments;

FIG. 2 depicts a null flow control serial signal remapping inside a serial interface converter according to one or more embodiments;

FIG. 4 is a top perspective view of a housing for a serial interface converter according to one or more embodiments;

FIG. 5 is a bottom perspective view of a housing for a serial interface converter according to one or more embodiments; and

FIG. 6 is a flowchart depicting a process for enabling serial communication between electronic devices according to one or more embodiments.

### DETAILED DESCRIPTION

The following detailed description is directed to methods and systems for detecting and repairing service problems in a network. In the following detailed description, references are made to the accompanying drawings that form a part hereof, and which are shown, by way of illustration, using specific embodiments or examples. Referring now to the drawings, in which like numerals represent like elements through the several figures, aspects of the methods and systems provided herein will be described.

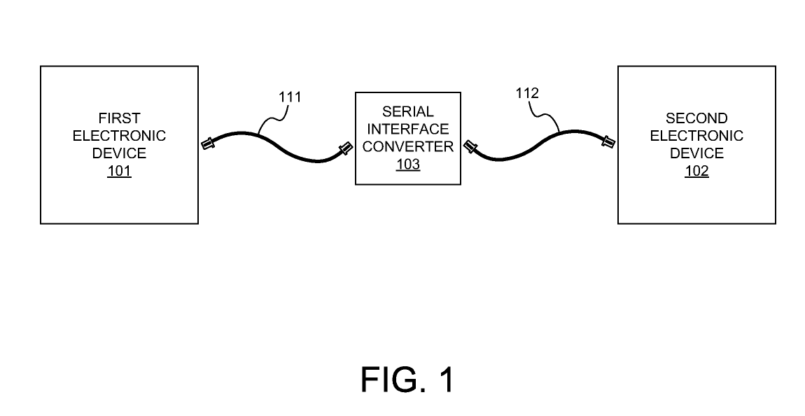

FIG. 1 is a block diagram illustrating an apparatus for enabling serial communication between disparate devices. A first electronic device 101 communicates with a second electronic device 102 using serial communication with the assistance of a serial interface converter 103. The first and second electronic devices 101, 102 may each represent a component in a computer network, including but not limited to a server, a personal computer, a router, a gateway, a modem, a printer, a scanner, a keyboard, a mouse, or any other electronic device capable of communicating using a serial communication standard. For example, the first electronic device 101 may be a CISCO router and the second electronic device 102 may be a DATAKIT network device. Both devices 101, 102 may be co-located in a data center, a central office, a server farm, or some other facility. The serial communication between the first and second electronic devices 101, 102 may enable a technician to dial-in to the first electronic device 101 and retrieve management information and/or make adjustments to a device configuration. Other uses for serial communication between the first and second electronic devices 101, 102 are known to those of skill in the art.

In order to communicate, the first and second electronic devices 101, 102 and the serial interface converter 103 are connected to each other using connectors and/or cables, such as cables 111, 112 illustrated in FIG. 1. The first electronic device 101 may communicate with the serial interface converter 103 over the cable 111 using a serial communication standard. Serial communication standards can include, but are not limited to, RS-232 , RS-485, Universal Serial Bus, TIA/EIA-562, and other serial communication standards. Serial communication standards typically include one or more data signal lines for transmission and receipt of data and may also include lines dedicated to signal ground and to handshaking. The second electronic device 102 may communicate with the serial interface converter 103 over the cable 112 also using a serial communication standard. The serial communication standards utilized by the first and second electronic devices 101, 102 may be different from each other. The first and second electronic devices 101, 102 may also use the same or a similar standard for electric signaling, but utilize different wiring schemes. The differences between the wiring schemes and/or serial communication standards may prevent the first and second electronic devices 101, 102 from easily being connected directly to each other. A wiring scheme may include the assignment of particular electrical signals to pins of a connector or wires of a cable, for example. A serial communication standard may require the use of a particular set of electrical signals, but the same or similar signals may be located on different pins or wires in different wiring schemes.

The cable 111 connected to the first electronic device 101 and the cable 112 connected to the second electronic device 102 may be similar and include similar connectors at the ends connecting to serial interface converter 103. For example, the cables 111, 112 may both be eight pin, eight conductor (8P8C) cables, sometimes referred to as RJ-45 cables. The cables 111, 112 may be rolled, crossover, or straight. It should be appreciated that other cables may be utilized having more or fewer conductors and/or having different connectors, such as 25-pin D-Sub or 9-pin D-Sub connectors. In between the two cables 111, 112, the serial interface converter 103 may remap the signals in order to convert from one serial communication standard and/or wiring scheme to another. Details of one possible signal remapping are provided below.

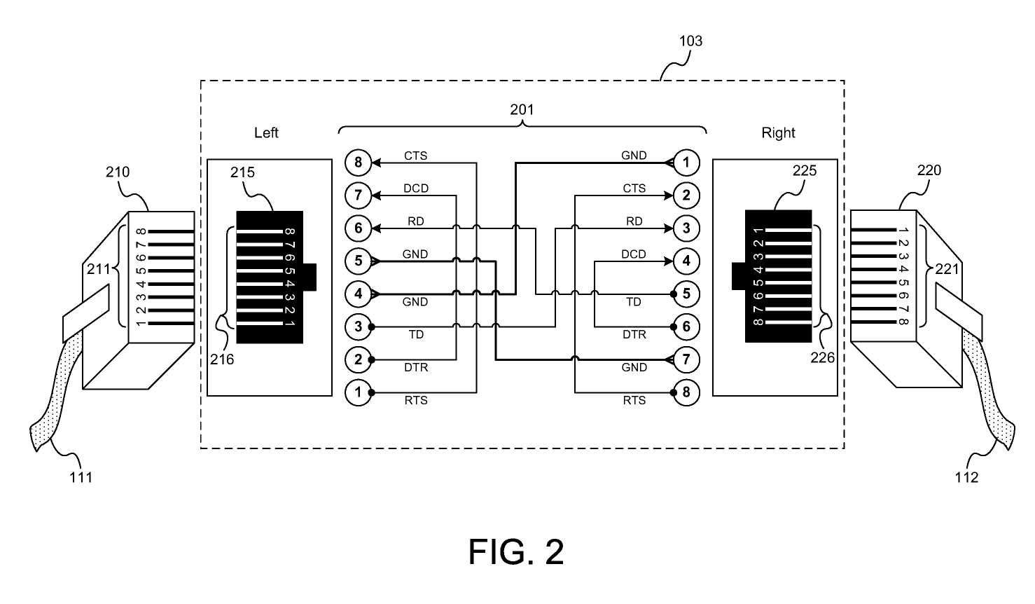

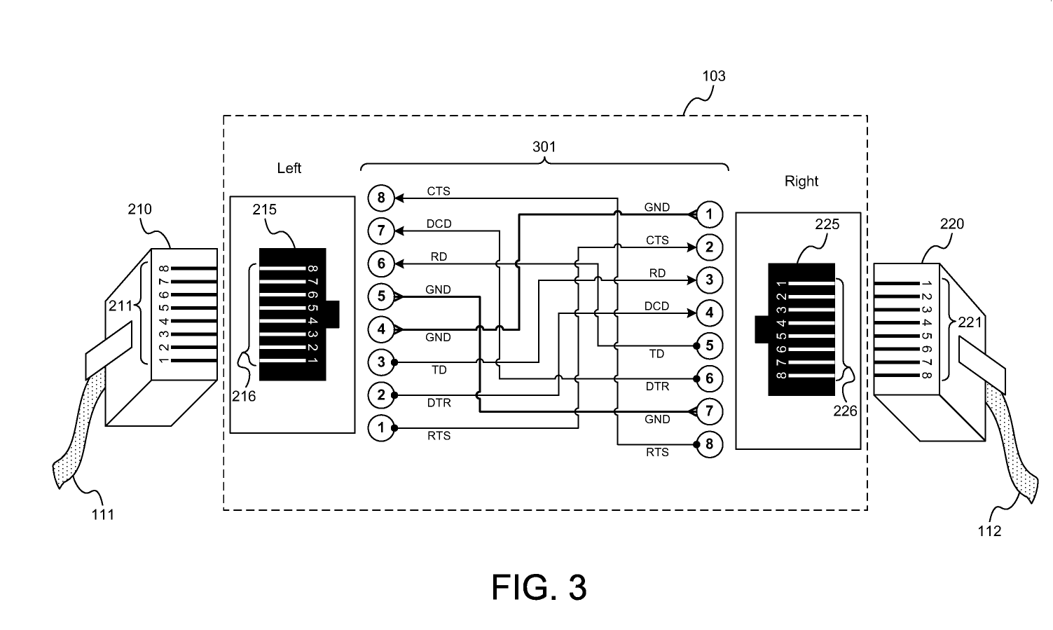

FIG. 2 depicts a signal remapping which may take place inside the serial interface converter 103. At least some of the signals used for serial communication by the first electronic device 101 are presumed to be the same or similar to at least some of the signals used by the second electronic device 102. Here, the cable 111 includes a connector 210 which houses a set of electrical pins 211. Although the connector 210 is depicted here as an 8P8C modular plug, other types of connectors, including other male and female connectors may be used to terminate the cable 111. Similarly, the cable 112 includes a connector 220 housing a set of electrical pins 221. The connector 220 is also an 8P8C modular plug, but may include other male and female connectors similar to the cable 111.

Although depicted in a disconnected state, connector 210 can be inserted into a cable port 215 housing a set of electrical pins 216, here an 8P8C modular jack, making electrical connections between each of the electrical pins 211 of the cable 111 and the respective electrical pins 216 of the cable port 215. Similarly, the connector 220 can be inserted into a cable port 225 housing a set of electrical pins 221, here an 8P8C modular jack, making the electrical connections between each of the electrical pins 221 of the cable 112 and the respective electrical pins 226 of the cable port 225.

The serial interface converter 103 remaps at least some of the electrical signals from the first electronic device 101 from/to the second electronic device 102 in order to orient the electrical signals properly for the different wiring schemes of the first and second electronic devices 101, 102. A wiring diagram 201 is included in FIG. 2 as an example of the remapping of connections effected by the serial interface converter 103. The remapping of the wiring diagram 201 may be implemented using wires connected between posts, using a printed circuit board, using a programmable or processing device, or any other method for making the electrical connections between the two cable ports 215, 225. The remapping of the wiring diagram 201 may be implemented or updated on the fly, using software or hardware switching or programming. Alternatively, the remapping may be hardwired at the time of manufacture of the serial interface converter 103.

Table 1 below summarizes the connections which may be utilized when converting serial communication between a CISCO device and a DATAKIT device. CISCO devices may utilize a standard Yost wiring scheme. The “Left” and “Right” labels are provided merely as references for the first and second electronic device 101, 102 and are not intended to imply an orientation to the first and second electronic devices 101, 102.

TABLE 1
Yost to Datakit Serial Remapping without Flow Control

| | | Left Port | Connects | Right Port | Connects |
|---|---|---|---|---|---|
| Signal | | Pin (Yost) | To Pin | Pin (Datakit) | To Pin |
| Request to | RTS | 1 | Left - 8 | 8 | Right - 2 |
| Send | | | | | |
| Data Terminal | DTR | 2 | Left - 7 | 6 | Right - 4 |
| Ready | | | | | |
| Transmit Data | TD | 3 | Right - 3 | 5 | Left - 6 |
| Signal Ground | GND | 4 | Right - 1 | 1 | Left - 4 |
| Signal Ground | GND | 5 | Right - 7 | 7 | Left - 5 |
| Receive Data | RD | 6 | Right - 5 | 3 | Left - 3 |
| Data Carrier | DCD | 7 | Left - 2 | 4 | Right - 6 |
| Detect | | | | | |
| Clear to Send | CTS | 8 | Left - 1 | 2 | Right - 8 |

Some electrical connections in the cable ports 215, 225 may not be passed through from one port to the other. In the example of FIG. 2, handshake signals, including Request to Send, Data Terminal Ready, Data Carrier Detect, and Clear to Send, are not passed through between the two ports. These electrical connections may be remapped so as to double back onto different electrical pins of the same cable port 215, 225, for example. The example of the wiring diagram 201 depicts a null flow control configuration, which does not pass handshaking signals through, and may allow the monitoring of a reboot by one of the electrical devices 101, 102 since handshakes may not be required to communicate serially. According to embodiments, when handshake signals are doubled back, a device, such as the second electronic device 102, for example, handshakes itself in order to initiate communication with the first electronic device 101. As illustrated in FIG. 2, for example, the request to send (RTS) signal of the second electronic device 102 is routed back instead of passing through to the first electronic device 101, causing the second electronic device 102 to handshake itself in order to initiate communication with the first electronic device 101.

Other remappings of signals are possible, as demonstrated in FIG. 3, which depicts another signal remapping occurring within the serial interface converter 103. Unlike the example of FIG. 2, FIG. 3 depicts a full flow control configuration, in which handshaking signals are passed through between the first and second electronic devices 101, 102. A wiring diagram 301 shows that all handshaking signals are passed to/from the first electronic device 101 from/to the second electronic device 102. Table 2 below summarizes the connections of FIG. 3 which may be utilized when converting serial communication between a Yost-style device and a DATAKIT device.

TABLE 2
Yost to Datakit Serial Remapping with Flow Control

| | | Left Port | Connects | Right Port | Connects |
|---|---|---|---|---|---|
| Signal | | Pin (Yost) | To Pin | Pin (Datakit) | To Pin |
| Request to | RTS | 1 | Right - 2 | 8 | Left - 8 |
| Send | | | | | |
| Data Terminal | DTR | 2 | Right - 4 | 6 | Left - 7 |
| Ready | | | | | |
| Transmit Data | TD | 3 | Right - 3 | 5 | Left - 6 |
| Signal Ground | GND | 4 | Right - 1 | 1 | Left - 4 |
| Signal Ground | GND | 5 | Right - 7 | 7 | Left - 5 |
| Receive Data | RD | 6 | Right - 5 | 3 | Left - 3 |
| Data Carrier | DCD | 7 | Right - 6 | 4 | Left - 2 |
| Detect | | | | | |
| Clear to Send | CTS | 8 | Right - 8 | 2 | Left - 1 |

Other remappings may be available, and may include the splitting or combining of signal lines. In addition, remapping of signals within the serial interface converter 103 may include voltage adjustments, signal processing, buffering, signal shaping, and other techniques required to convert serial communication from one standard to another. For example, multiple signal grounds associated with the first electronic device 101 may, in the course of conversion, be electrically connected if the second electronic device 102 only requires a single signal ground.

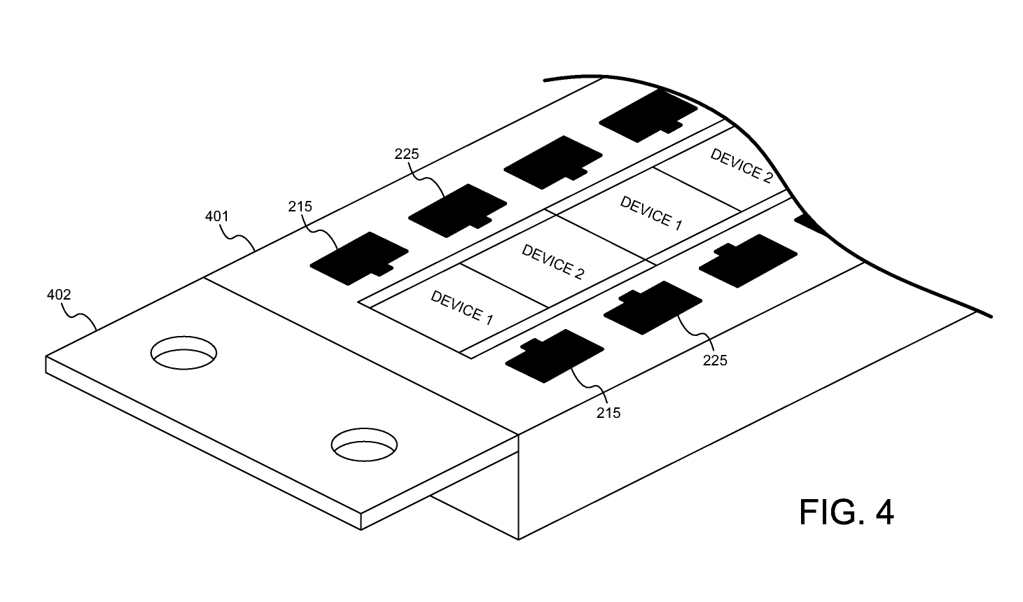

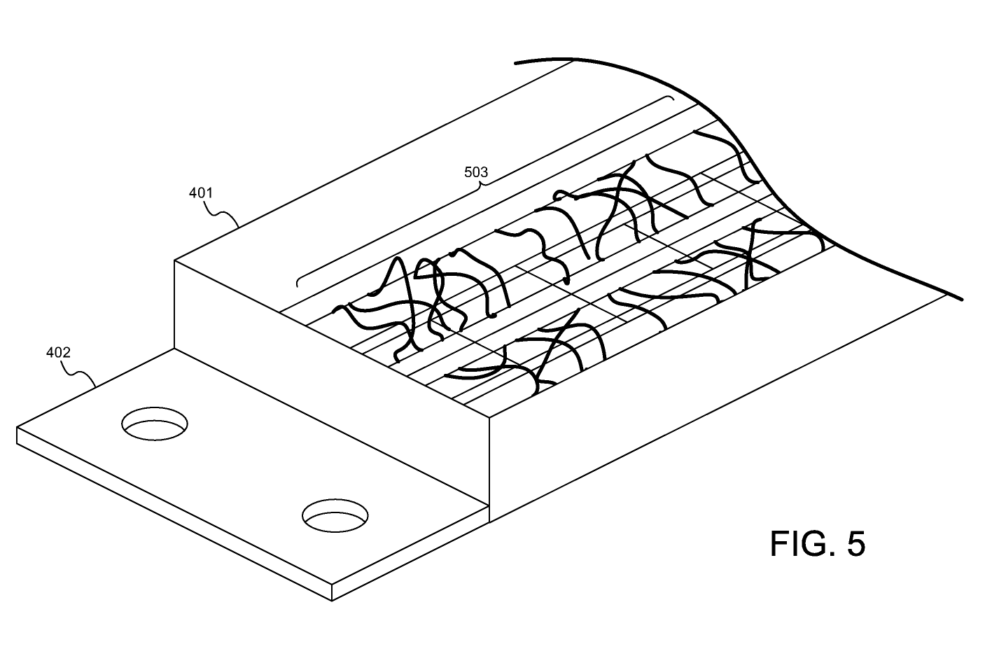

FIGS. 4 and 5 depict top and bottom views of an example of a housing 401 for the serial interface converter 103. FIG. 4 is a top view of the housing 401, showing a multitude of pairs of cable ports 215, 225, and also a rack mount bracket 402. The multitude of pairs of cable ports 215, 225 enable multiple sets of the electronic devices 101, 102 to utilize the serial interface converter 103 simultaneously. The pairs of cable ports 215, 225 may include some pairs which are intended for converting between other additional serial communication standards. The housing 401 may include 8, 12, 24, 48 or more pairs of cable ports 215, 225. The housing may be include a HUBBELL patch panel, or similar pre-assembled housing which is modified for use as the serial interface converter 103. It should be appreciated that any type of housing capable of containing the serial interface converter 103 may be used. The rack mount bracket 402 enables the housing 401 for the serial interface converter 103 to be mounted in a standard 19-inch (or other sized) rack with other electrical devices and equipment.

FIG. 5 is a bottom view of the housing 401, showing a collection of wires 503 connecting the cable ports 215, 225. The wires are connected to each pair of cable ports 215, 225 using a wiring diagram 201, 301 similar to those shown in FIGS. 2 and 3. The wires 503 may be connected to the cable ports 215, 225 by being soldered or pushed into punch down connectors (not shown) in a patch panel. Other methods for electrically connecting the pins of the cable ports 215, 225 are available, as discussed above, and may include the use of a ribbon cable, a printed circuit board, and other techniques for electrically connecting the pins of two connectors. If remapping requires the use of additional electrical components, including, for example resistors, capacitors, inductors, diodes, voltage regulators, transistors, microcontrollers, or digital signal processors, then these components might be included within the housing 401. Such additional components may be attached to and electrically connected to each other via a printed circuit board.

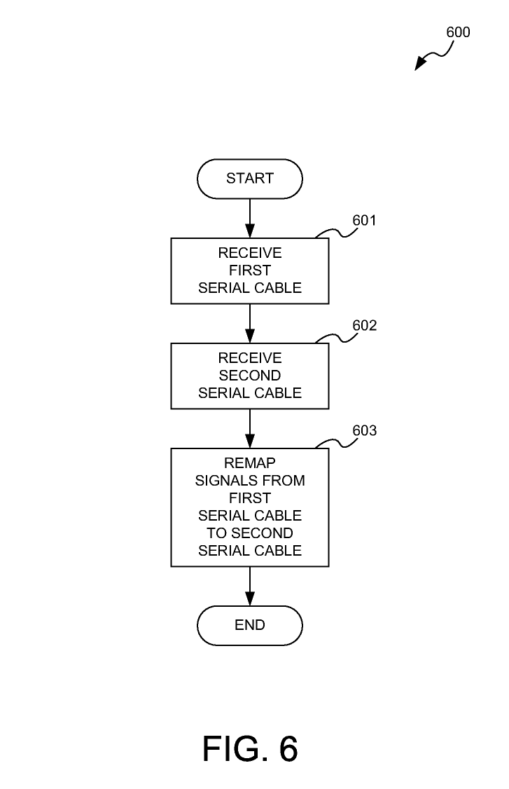

FIG. 6 is a flowchart depicting a process 600 for enabling serial communication between two electronic devices 101, 102. The process 600 may be implemented within a housing and may be used by embodiments of the serial interface converter 103. The operations of the various implementations presented, may be (1) a sequence of acts or program modules running on one or more processing devices and/or (2) interconnected circuits or circuit modules within the serial interface converter 103. The implementation is a matter of choice dependent on which of the embodiments are implemented. Accordingly, the functional operations making up the implementations are referred to variously as operations, structural devices, acts, or modules. It will be recognized by one skilled in the art that these operations, structure devices, acts, and modules may be implemented in software, in special purpose digital logic, in special purpose hardware and/or any combination thereof without deviating from the spirit and scope of the attached claims. Moreover, it will be apparent to those skilled in the art that the operations described may be combined, divided, reordered, skipped, and otherwise modified, also without deviating from the spirit and scope of the attached claims.

At 601, the start of process 600, a cable 111 and/or connector 210 housing signals for serial communication is received by the serial interface converter 103. This may be, for example, a standard 8P8C serial cable with a modular connector, plugged into the cable port 215 of the serial interface converter 103. Other types of cables, wires, optical fibers, connectors, and other mediums for delivering serial communication may also be received by the serial interface converter 103. For example, a 25-pin or 9-Pin DSub connector may alternatively be used. At 602, the serial interface converter 103 receives a second cable 112 and/or connector 220 housing signals for serial communication. This cable 112 and/or connector 220 may be plugged into the cable port 225 of the serial interface converter 103. As with the cable 111 plugged into the cable port 215, any type of cable, wire, optical fiber, connector, or other media may be utilized. The connectors and/or cables may be physically the same, or may vary between the two cable ports 215, 225. Even if the connectors and/or cables are physically the same, the signals mapped to each of the conductors in the cables and/or connectors may vary between the two. This may be referred to as the two cables and/or connectors having different wiring schemes.

At 603, the signals received at the cable port 215 are then remapped by the serial interface converter 103 to send the signals differently through the cable port 225. For example, electrical connections made between the pins of the cable port 215 and the cable port 225 may be remapped from one pin to another. This may be accomplished by attaching wires in different configurations between and among the cable ports 215, 225. Alternatively, the electrical connections carrying serial communications may be remapped using a logic array such as a field programmable gate array (FPGA), a complex programmable logic device (CPLD), a processing device, such as a microprocessor or a microcontroller, or any other technique for remapping the electrical signals between and among the pins of the cable ports 215, 225. The remapping may be programmed into serial interface converter 103 using a programming method, as with the FPGA or CPLD. The remapping may alternatively be programmatically modified or updated using a program module as may be utilized by a microprocessor or microcontroller. Additional methods for setting or modifying the remapping of signals between the two cable ports 215, 225 may involve setting or changing one or more physical switches associated with the serial interface converter 103.

Although the subject matter presented herein has been described in conjunction with one or more particular embodiments and implementations, it is to be understood that the invention defined in the appended claims is not necessarily limited to the specific structure, configuration, or functionality described herein. Rather, the specific structure, configuration, and functionality are disclosed as example forms of implementing the claims.

The subject matter described above is provided by way of illustration only and should not be construed as limiting. Various modifications and changes may be made to the subject matter described herein without following the example embodiments and applications illustrated and described, and without departing from the true spirit and scope of the present invention, which is set forth in the following claims.

What is claimed is:

1. An apparatus for enabling serial communications between two electronic devices, the apparatus comprising:
a housing;
a first cable port within the housing for receiving a first connector conforming to a standard, wherein the first cable port comprises a first plurality of electrical pins and is associated with a first serial wiring scheme;
a second cable port within the housing for receiving a second connector conforming to the standard, wherein the second cable port comprises a second plurality of electrical pins and is associated with a second serial wiring scheme; and
a plurality of electrical connections between the first plurality of electrical pins and the second plurality of electrical pins, wherein the plurality of electrical connections effect a remapping of signals from the first plurality of electrical pins to the second plurality of electrical pins.

2. The apparatus of claim 1, wherein the first and second cable ports both comprise eight pin, eight connector (8P8C) modular jacks.

3. The apparatus of claim 2, wherein the first serial wiring scheme comprises a Yost standard wiring scheme.

4. The apparatus of claim 3, wherein the second serial wiring scheme comprises a DATAKIT wiring scheme.

5. The apparatus of claim 1, wherein the housing comprises one or more mounting brackets so as to make the housing rack-mountable.

6. The apparatus of claim 1, wherein the plurality of electrical connections are reconfigurable by a user.

7. The apparatus of claim 1, wherein the housing comprises:
a plurality of additional cable ports; and
a second plurality of electrical connections to effect remapping of signals for a plurality of electrical pins of the plurality of additional cable ports.

8. The apparatus of claim 1, wherein a first one of the first plurality of electrical pins is associated with a first flow control signal.

9. The apparatus of claim 8, wherein the first flow control signal is remapped to connect to a second one of the first plurality of electrical pins that is associated with a second flow control signal.

10. The apparatus of claim 8, wherein the first flow control signal is remapped to connect to a first one of the second plurality of electrical pins that is associated with a second flow control signal.

11. An system for remapping signals used in serial communication, the system comprising:
means for receiving a first cable connector conforming to a connector standard, the means associated with a first plurality of signals associated with a first wiring scheme;
means for receiving a second cable connector conforming to the connector standard, the means associated with a second plurality of signals associated with a second wiring scheme; and
means for remapping the first plurality of signals from the first wiring scheme to the second wiring scheme for electrically connecting the first and second pluralities of signals.

12. The system of claim 11, wherein the means for receiving the first cable connector conforming to the connector standard comprises means for receiving an eight pin, eight connector (8P8C) modular plug.

13. The system of claim 12, wherein the means for remapping the first plurality of signals from the first wiring scheme to the second wiring scheme comprises means for remapping signals from a Yost wiring scheme to the second wiring scheme.

14. The system of claim 11, further comprising:
means for encasing the means for receiving the first cable connector, the means for receiving the second cable connector, and means for remapping the first plurality of signals from the first wiring scheme to the second wiring scheme.

15. The system of claim 14, wherein the means for encasing comprises a rack-mountable housing.

16. The system of claim 11, wherein the means for receiving the first cable connector comprises means for receiving a first flow control signal.

17. The system of claim 16, wherein the means for remapping signals comprises means for remapping the first flow control signal to connect to a second flow control signal associated with the first plurality of signals.

18. The system of claim 16, wherein the means for remapping signals comprises means for remapping the first flow control signal to connect to a first flow control signal associated with the second plurality of signals.

19. An apparatus for enabling serial communications between two devices utilizing different serial wiring schemes, the apparatus comprising:
a rack-mountable housing;
a first 8P8C modular jack within the rack-mountable housing for receiving a first 8P8C modular plug, wherein the first 8P8C modular jack houses a first set of eight electrical pins and is associated with a first serial wiring scheme;
a second 8P8C modular jack within the rack-mountable housing for receiving a second 8P8C modular plug, wherein the second 8P8C modular jack houses a second set of eight electrical pins and is associated with a second serial wiring scheme; and
a plurality of electrical connections between the first 8P8C modular jack and the second 8P8C modular jack, wherein the plurality of electrical connections effect a remapping of signals from the first set of eight electrical pins to the second set of eight electrical pins.

20. The apparatus of claim 19, wherein the first serial wiring scheme comprises a Yost wiring scheme.
